(19) United States
(12) Patent Application Publication
(10) Pub. No.: US 2001/0003163 A1
(43) Pub. Date: Jun. 7, 2001

(54) Automation system with radio sensor

(76) Inventors: Ulrich Bungert, Stein (DE); Frank Kraska, Amberg (DE)

Correspondence Address: SUGHRUE, MION, ZINN, MACPEAK & SEAS, PLLC, SUITE 800, 2100 PENNSYLVANIA AVENUE, N.W., WASHINGTON, DC, 20037-3213, US

(21) Appl. No.: 09/736,183

(22) Filed: Dec. 15, 2000

Related U.S. Application Data
(63) Continuation of application No. PCT/DE99/01633, filed on Jun. 2, 1999.

(30) Foreign Application Priority Data
Jun. 15, 1998 (DE) 19826513.1

(51) Int. Cl. G05B 11/01; G08B 29/00; G08B 13/14; H04Q 5/22

(52) U.S. Cl. 700/12; 340/539; 340/10.34; 340/572.1

(57) ABSTRACT

An automation system including a control device for controlling a processing device having at least one sensor for transmitting sensor data from the processing device to the control device. The sensor comprises a radio transmission device for providing wireless transmission of the sensor data from the transmission device to a radio reception device connected to or located in the control device.

This is a Continuation of International Application PCT/DE99/01633 with an international filing date of Jun. 2, 1999, the disclosure of which is incorporated herein by reference.

### BACKGROUND OF THE INVENTION

1. Field of the Invention

The present invention relates to an automation system having a control device for controlling a processing device, such as a production device. The system has at least one sensor which generates sensor data to be wirelessly transmitted from the processing device to the control device.

The present invention also relates to a sensor arrangement having a radio transmitter in a processing device and a radio receiver in a control device, wherein the radio transmitter wirelessly transmits sensor data to the radio receiver.

2. Description of the Related Art

Automation systems of this type include, e.g., control devices and processing devices used in construction, packaging, or storage industries. Assessing operating conditions of such automation systems requires sensors that determine the position of certain parts of the processing device. This position information is sent from the processing device to the control device in order to initiate control measures that may be necessary. The sensors are wired to the control device either directly or via a data bus.

### SUMMARY OF THE INVENTION

It is an object of the present invention to reduce the expense of installing sensors and sensor arrangements.

Installing a sensor involves simply placing the sensor with a radio transmitter at a desired measuring point. The sensor data is transmitted from a radio transmitter of a processing device to a radio receiver of a control device. Thus, no wiring between the radio transmitter and receiver is necessary. Preferably, the transmitter and receiver are located, respectively, at the processing device and at the control device, and communicate via an interface.

In order to enable transmission of data in the opposite direction, i.e., from the control device to the processing device, the radio transmitter of the processing device and the radio receiver of the control device are each designed as a combination radio transmitter/receiver, also known as a radio transceiver. The radio transceiver of the control device may transmit to the radio transceiver of the processing device activation data for activating the sensor of the processing device.

The radio receiver (or transceiver) of the control device may include an arrangement for receiving sensor data from more than one sensor in order to reduce hardware expenses, allowing the control device to communicate with a multiplicity of sensors. The radio receiver is preferably incorporated directly into the control device itself. Alternatively, this radio receiver may be linked to the control device as a radio receiver module either directly or via a data bus connection.

In order to guarantee the secure transmission of data via the radio interface, a data protocol for the data transmitted between the radio transceivers of the processing device and control device provides for a first data area designating sensor identification data and a second data area designating the sensor data to be transmitted.

In the same manner, in order to enable the secure activation of sensors via the radio interface, a data protocol for data transmitted from the radio transmitter of the control device to the radio receiver of the processing device provides for a first data area designating sensor identification data and a second data area designating the control data to be transmitted.

The sensor data and/or control data preferably consist of binary signals, thus keeping the expense of transmitting the sensor data low. Depending on the extent of the sensor data and/or control data to be transmitted, the required allocation for these data areas could be kept as small as a single bit. In this case, it is possible to specify two conditions, 0 and 1.

The wiring required for operating the sensors can be further reduced by transmitting the energy required for supplying power from the control device to the radio transmitter of the processing device through electromagnetic emission.

### BRIEF DESCRIPTION OF THE DRAWINGS

The above objects and advantages of the present invention will become more apparent by describing in detail a preferred embodiment thereof with reference to the attached drawings in which:

FIG. 1 shows an automation system according to a first embodiment of the present invention;

FIG. 2(a) shows a data protocol for transmitting sensor data;

FIG. 2(b) shows a data protocol for transmitting control data;

FIG. 3 shows an automation system according to a second embodiment of the present invention;

FIG. 4 shown an automation system according to a third embodiment of the present invention; and

FIG. 5 shows an automation system according to a fourth embodiment of the present invention.

### DETAILED DESCRIPTION OF THE PREFERRED EMBODIMENTS

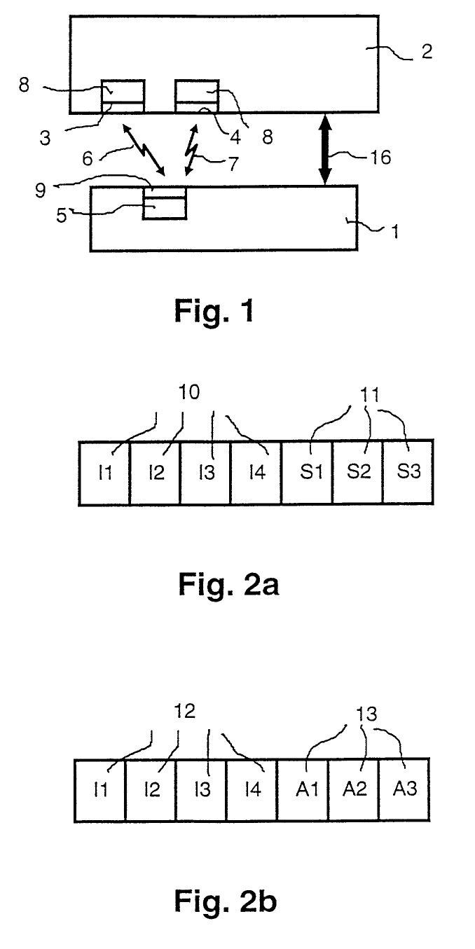

FIG. 1 shows an automation system according to the first embodiment of the present invention. This automation system, which can be used, for example, in production automation, includes a processing device 2, such as a production device, as well as a control device 1 for controlling the processing device 2.

Sensors 3, 4 are located in or near the processing device 2 and record sensor data, such as positions of certain parts of the processing device 2. The sensors 3, 4 are each provided with a radio transmission device 8, which transmits the sensor data recorded by the sensor 3, 4 to the control device 1 via a radio interface 6, 7. For this purpose, the control device 1 is provided with a sensor data receiver 5 and a radio receiver 9. The radio receiver 9 receives the sensor data transmitted via the radio interface 6, 7, which are then further processed in the automation device. A connecting cable 16 can also be interconnected between the control device 1 and the processing device 2 for additional data exchange.

The main task of the radio transmitters 8 of the sensors 3, 4 is to transmit the recorded sensor data to the control device 1 as binary information. Such binary information may include, for example, the position of a closed or opened valve, that is, 0 for open and 1 for closed.

The transmission device 8 and reception device 9 are each designed as a combined transmitter/receiver device, also known as a transceiver, thus enabling bi-directional communication via the radio interfaces 6, 7. The communication links from the control device 1 to the processing device 2 allow, for instance, the transceivers 8 of the sensors 3, 4 to transmit to the control device 1 a request for measured data.

To allow for the selection of a specific sensor 3, 4, each sensor is assigned an individual identification signal uniquely designating each specific sensor. Upon receiving a request for the transmission of sensor data, the sensor 3, 4 can, for example, transmit the sensor data directly to the control device 1 via a duplex channel. If the sensor data is transmitted via a separate radio channel, the sensor 3, 4 first transmits an identification signal before the sensor data is transmitted. This identification signal associates the measured data with its corresponding sensor 3, 4. See FIG. 2(a). The advantage of creating a binary radio sensor 3, 4 is that in the installation of the sensors 3, 4 no wiring is required for a data connection between processing device 2 and control device 1.

Depending on the application, the sensors 3, 4 can be supplied with power via solar cells, and if necessary, in combination with an energy storage unit such as an accumulator, a capacitor, etc. In addition, there is also the alternative or additional advantageous possibility of supplying power to the sensors 3, 4 on an electromagnetic basis via radio.

FIG. 2(a) shows a basic example of a data protocol 10, 11, which regulates the transmission of the sensor data 11 from the sensors 3, 4 of the processing device 2 to the sensor data receiver 5 of the control device 1. See FIG. 1. The data protocol consists of a first data area 10 for sensor identification data and a second data area 11 for sensor data to be transmitted. The first data area 10 indicates a four-digit identification signal I1-I4, which clearly identifies the respective sensor. The second data area 11 contains sensor data S1-S3 consisting of binary numbers, which represent, for example, position data of the processing device 2.

FIG. 2(b) shows a data protocol, which is analogous to that of FIG. 2(a), for control data transmitted from the control device 1 to the sensors 3, 4 of the processing device 2 via the radio interfaces 6, 7. Again, a first data area 12 contains sensor identification data I1-I4, while a second data area 13 contains control data A1-A3. One particular function of the control data 13 is to request a sensor to transmit current sensor data. One advantage of addressing a sensor specifically is that the radio transmitter 8 of the sensor transmits sensor data to the control device 1 only when it is needed, thereby reducing the energy consumption of the radio transmitter 8 to a minimum.

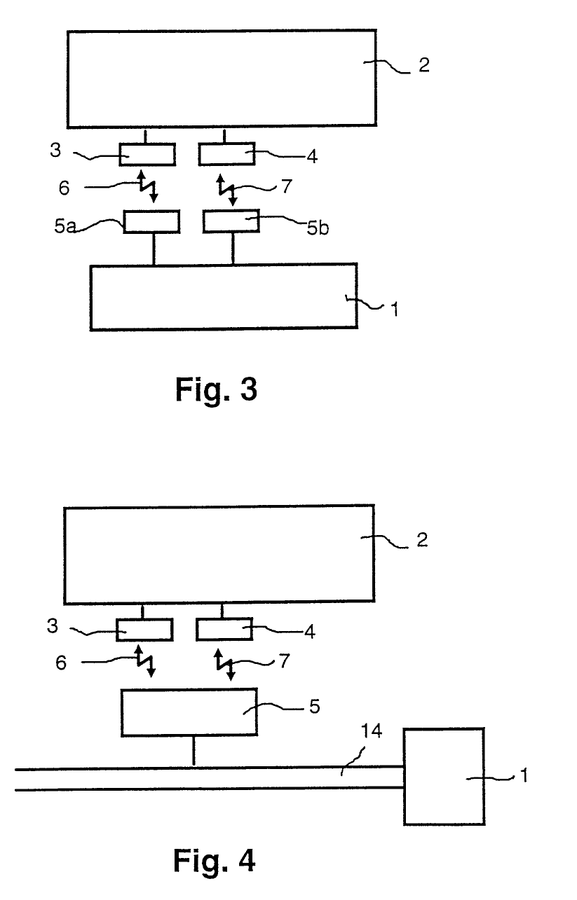

FIG. 3 shows an automation system according to the second embodiment of the present invention. As in the first embodiment, the automation system of the second embodiment includes a processing device 2 as well as an associated control device 1. Again, sensors 3, 4, which can be connected via radio interfaces 6, 7 to sensor data receivers 5a, 5b, are located near the processing device 2. The sensor data receivers 5a, 5b are arranged in the area of or are connected to the control device 1.

In contrast to the first embodiment shown in FIG. 1, in which the radio reception device 9 serves to receive several sensor signals, the second embodiment shown in FIG. 3 has two separate sensor data receivers 5a, 5b. Here, the sensor 3 located near the processing device 2 communicates with the sensor data receiver 5a via radio interface 6, while the sensor 4 communicates with the sensor data receiver 5b via radio interface 7. To avoid repetition with regard to the function of the automation system according to the first embodiment, reference is made here to the explanations given in connection with FIGS. 1, 2(a) and 2(b).

FIG. 4 shows an automation system according to a third embodiment of the present invention. The automation system consists of a processing device 2 as well as a control device 1. Sensors 3, 4, which communicate with a sensor data receiver 5 via radio interfaces 6, 7, are located near the processing device 2. The sensor data receiver 5 is connected to a data bus 14, which is connected to the control device 1.

The data bus 14, which can be, e.g., a so-called actuator sensor interface, serves primarily to transmit measurement signals. In addition to the sensor data receiver 5 shown in FIG. 4, the data bus 14 can be connected to other sensors, etc. (not shown).

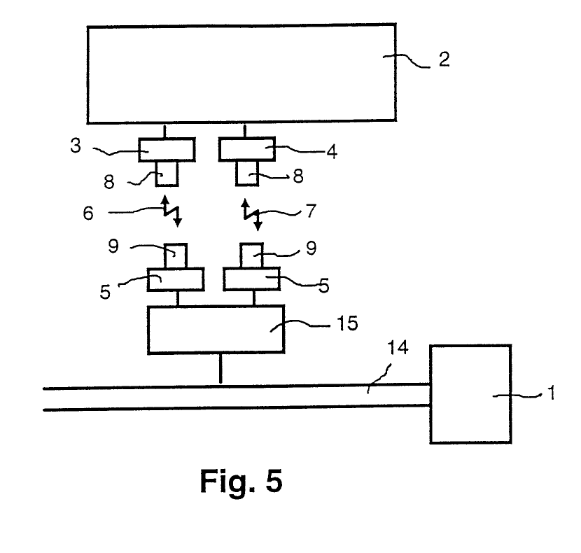

FIG. 5 shows an automation system according to a fourth embodiment of the present invention. Like the systems described above, this system includes a control device 1 as well as a processing device 2. A data bus 14, like the one included in the system of the third embodiment, is connected to the control device 1. A data bus radio module 15 connects the data bus 14 with sensor data receivers 5 and transceivers 9. The sensor data receivers 5 communicate via radio interfaces 6, 7 with the sensors 3, 4, that are located near the processing device 2 and that are also provided with radio transceivers 8.

The advantage of the architecture shown in FIG. 5 is that the sensor and control data to be transmitted via the radio interface 6, 7 are linked centrally via the data bus radio module 15. This in turn reduces the expense of linking the individual sensor data receivers 5 to the data bus 14. In addition, compatibility for the link to the existing data bus 14 is ensured.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. An automation system including a control device for controlling a processing device and at least one sensor arrangement for transmitting sensor data provided by a sensor from the processing device to the control device, wherein the sensor arrangement contains a radio transmitter for providing wireless transmission of the sensor data to a radio receiver interconnected with the control device.

2. The automation system according to claim 1, wherein the radio transmitter of the processing device and the radio receiver of the control device are each a radio transceiver, and the radio transceiver of the control device transmits sensor control data to the radio transceiver of the processing device.

3. The automation system according to claim 1, wherein the radio receiver receives sensor data from a plurality of sensors.

4. The automation system according to claim 1, wherein the radio receiver is associated with a radio module that receives sensor data from a plurality of sensors and is connected directly to the control device.

5. The automation system according to claim 1, wherein the radio receiver is associated with a radio module that receives sensor data from a plurality of sensors and is connected to the control device.

6. The automation system according to claim 5, wherein the radio receiver is connected to the control device via a data bus.

7. The automation system according to claim 6, wherein a central data bus radio module is connected between the radio module and the data bus.

8. The automation system according to claim 1, wherein a data protocol for the data transmitted from the radio transmitter to the radio receiver provides a first data area associated with sensor identification data and a second data area associated with the transmitted sensor data.

9. The automation system according to claim 2, wherein a data protocol for the control data transmitted from the radio transceiver of the control device to the radio transceiver of the processing device provides a first data area associated with sensor identification data and a second data area associated with the control data.

10. The automation system according to claim 1, wherein the sensor data consists of binary signals.

11. The automation system according to claim 9, wherein the control data consists of binary signals.

12. The automation system according to claim 2, wherein energy providing the sensor with an operating current is transferred by electromagnetic emission from the control device to the sensor via the radio transceiver of the processing device.

13. An automation system comprising:
a control device;
a processing device controlled by the control device; and
a sensor arrangement comprising a sensor that obtains sensor data from the processing device;
wherein the sensor arrangement wirelessly transmits the sensor data from the processing device to the control device.

14. The automation system according to claim 13, wherein the processing device has a plurality of sensor arrangements.

15. The automation system according to claim 14, further comprising a data bus connecting the plurality of sensor arrangements with the control device.

16. The automation system according to claim 15, further comprising a central data bus radio module connecting the plurality of sensor arrangements with the data bus.

17. A sensor arrangement for an automation system having a control device for controlling a processing device, wherein the sensor arrangement has a sensor and a radio transmitter interconnected with the processing device for transmitting sensor data to a radio receiver interconnected with the control device.

18. The sensor arrangement according to claim 16, wherein the radio transmitter is a transceiver configured to receive activation data for activating the sensor from a transceiver of the control device that transmits to the transceiver of the processing device.
